(19) United States
(12) Patent Application Publication
(10) Pub. No.: US 2014/0005304 A1
(43) Pub. Date: Jan. 2, 2014

(54) NANOCOMPOSITE AND METHOD OF MAKING THE SAME

(71) Applicants: Radhika Suresh, Sugar Land, TX (US); Soma Chakraborty, Houston, TX (US)

(72) Inventors: Radhika Suresh, Sugar Land, TX (US); Soma Chakraborty, Houston, TX (US)

(73) Assignee: BAKER HUGHES INCORPORATED, Houston, TX (US)

(21) Appl. No.: 13/539,964

(22) Filed: Jul. 2, 2012

(51) Int. Cl. C08K 5/549; C08K 3/40; C08K 3/30; C08K 3/34; C08K 3/04; C08K 3/36

(52) U.S. Cl. CPC C08K 5/549; C08K 3/04; C08K 3/36; C08K 3/30; C08K 3/346; C08K 3/40
USPC 523/458; 524/267; 523/400; 525/342; 525/418; 525/461; 525/535; 525/537; 525/50; 523/468; 523/466

(57) ABSTRACT

A nanocomposite comprises: a polymer; and a nanofiller disposed in the polymer, the nanofiller comprising a first nanoparticle bonded to a second nanoparticle. A process of making a nanocomposite comprises: combining a silsesquioxane and a nanoparticle; bonding the nanoparticle to the silsesquioxane to make a nanofiller; and dispersing the nanofiller in a polymer to make the nanocomposite.

### BACKGROUND

To improve properties of polymers, bulk materials are sometimes added to a polymer matrix. However, some of these bulk materials also diminish performance characteristics or introduce unfavorable properties, for example, premature degradation of the polymer. Balancing the need for more robust polymer compositions with available bulk materials has proved challenging. Thus, new materials and methods to improve polymer materials would be well received in the art.

### BRIEF DESCRIPTION

The above and other deficiencies of the prior art are overcome by, in an embodiment, a nanocomposite comprising: a polymer; and a nanofiller disposed in the polymer, the nanofiller comprising a first nanoparticle bonded to a second nanoparticle.

In another embodiment, a process of making a nanocomposite comprises: combining a silsesquioxane and a nanoparticle; bonding the nanoparticle to the silsesquioxane to make a nanofiller; and dispersing the nanofiller in a polymer to make the nanocomposite.

### DETAILED DESCRIPTION

A detailed description of one or more embodiments is presented herein by way of exemplification and not limitation.

It has been found that a nanocomposite of a certain nanofiller and polymer exhibits an increased degradation temperature as compared to the native polymer. The nanofiller is compatible with and interacts with the polymer such that the nanofiller easily disperses in the polymer. In addition, a synergistic effect of the nanofiller and polymer enhances performance and properties of the nanocomposite such as flame retardation, increased time to ignition, or improved self-extinguishing time over the native polymer.

In an embodiment, a nanocomposite includes a polymer and a nanofiller disposed in the polymer. The nanofiller has a first nanoparticle bonded to a second nanoparticle.

Nanoparticles, from which the nanofiller is formed, are generally particles having an average particle size, in at least one dimension, of less than one micrometer (□m). As used herein “average particle size” refers to the number average particle size based on the largest linear dimension of the particle (sometimes referred to as “diameter”). Particle size, including average, maximum, and minimum particle sizes, may be determined by an appropriate method of sizing particles such as, for example, static or dynamic light scattering (SLS or DLS) using a laser light source. Nanoparticles may include both particles having an average particle size of 250 nm or less, and particles having an average particle size of greater than 250 nm to less than 1 □m (sometimes referred in the art as “sub-micron sized” particles). In an embodiment, a nanoparticle may have an average particle size of about 0.1 nanometers (nm) to about 500 nm, specifically 0.5 nm to 250 nm, more specifically about 1 nm to about 150 nm, more specifically about 5 nm to about 125 nm, and still more specifically about 5 nm to about 75 nm. The nanoparticles may be monodisperse, where all particles are of the same size with little variation, or polydisperse, where the particles have a range of sizes and are averaged. Generally, polydisperse nanoparticles are used. Nanoparticles of different average particle size may be used, and in this way, the particle size distribution of the nanoparticles may be unimodal (exhibiting a single size distribution), bimodal exhibiting two size distributions, or multi-modal, exhibiting more than one particle size distribution.

The minimum particle size for the smallest 5 percent of the nanoparticles may be less than 2 nm, specifically less than or equal to 1 nm, and more specifically less than or equal to 0.5 nm. Similarly, the maximum particle size for 95% of the nanoparticles can be greater than or equal to 900 nm, specifically greater than or equal to 750 nm, and more specifically greater than or equal to 500 nm. The nanoparticles can have a high surface area of greater than 300 m²/g, and in a specific embodiment, 300 m²/g to 1800 m²/g, specifically 500 m²/g to 1500 m²/g.

According to an embodiment, the first nanoparticle is a silsesquioxane. Silsesquioxanes, also referred to as polysilsesquioxanes, polyorganosilsesquioxanes, or polyhedral oligomeric silsesquioxanes (POSS) derivatives, are polyorganosilicon oxide compounds of general formula RSiO_{1.5} (where R is a hydrogen, inorganic group, or organic group such as methyl) having defined closed or open cage structures (closo or nido structures, which are called respectively completely condensed or incompletely structures). Silsesquioxanes can be prepared by acid and/or base-catalyzed condensation of functionalized silicon-containing monomers such as tetraalkoxysilanes including tetramethoxysilane and tetraethoxysilane, alkyltrialkoxysilanes such as methyltrimethoxysilane and methyltrimethoxysilane.

In an embodiment, the first nanoparticle is a silsesquioxane that has a closed cage structure, an open cage structure, or a combination comprising at least one of the foregoing. The silsesquioxane can have any shape of cage structure such as cubes, hexagonal prisms, octagonal prisms, decagonal prisms, dodecagonal prisms, and the like. Additionally, the cage structure of the silsesquioxane comprises from 4 to 30 silicon atoms, specifically, 4 to 20 silicon atoms, and more specifically 4 to 16 silicon atoms, with each silicon atom in the cage structure being bonded to oxygen. It should be noted that the term “cage structure” is meant to include the SiO_{1.5} portion of the general silsesquioxane formula RSiO1.5, and not the R-group.

The second nanoparticle comprises nanographite, nanographene, graphene fiber, carbon nanotubes, or combinations comprising at least one of the foregoing. Nanographite is a cluster of plate-like sheets of graphite, in which a stacked structure of one or more layers of graphite, which has a plate-like two dimensional structure of fused hexagonal rings with an extended delocalized □-electron system, are layered and weakly bonded to one another through □-□ □ stacking interaction. Nanographite has both micro-and nano-scale dimensions, such as for example an average particle size of 1 to 20 □m, specifically 1 to 15 □m, and an average thickness (smallest) dimension in nano-scale dimensions, and an average thickness of less than 1 □m, specifically less than or equal to 700 nm, and still more specifically less than or equal to 500 nm.

In an embodiment, the nanoparticle is a graphene including nanographene and graphene fibers (i.e., graphene particles having an average largest dimension of greater than 1 mm and an aspect ratio of greater than 10, where the graphene particles form an interbonded chain). Graphene and nanographene, as disclosed herein, are effectively two-dimensional particles of nominal thickness, having of one or more layers of fused hexagonal rings with an extended delocalized □-electron system, layered and weakly bonded to one another through □-□ □ stacking interaction. Graphene in general, including nanographene, can be a single sheet or a stack of several sheets having both micro- and nano-scale dimensions, such as in some embodiments an average particle size of 1 to 20 □m, specifically 1 to 15 □m, and an average thickness (smallest) dimension in nano-scale dimensions of less than or equal to 50 nm, specifically less than or equal to 25 nm, and more specifically less than or equal to 10 nm. An exemplary nanographene can have an average particle size of 1 to 5 □m, and specifically 2 to 4 □m. In addition, smaller nanoparticles or sub-micron sized particles as defined above may be combined with nanoparticles having an average particle size of greater than or equal to 1 □m. In a specific embodiment, the second nanoparticle is a nanographene.

Graphene can be prepared by exfoliation of graphite or by a synthetic procedure by “unzipping” a nanotube to form a nanographene ribbon, followed by derivatization of the nanographene to prepare, for example, graphene oxide.

Exfoliation to form graphene or nanographene can be carried out by exfoliation of a graphite source such as graphite, intercalated graphite, and nanographite. Exemplary exfoliation methods include, but are not limited to, fluorination, acid intercalation, acid intercalation followed by thermal shock treatment, and the like, or a combination comprising at least one of the foregoing. Exfoliation of the nanographite provides a nanographene having fewer layers than non-exfoliated nanographite. It will be appreciated that exfoliation of nanographite can provide the nanographene as a single sheet only one molecule thick, or as a layered stack of relatively few sheets. In an embodiment, exfoliated nanographene has fewer than 50 single sheet layers, specifically fewer than 20 single sheet layers, specifically fewer than 10 single sheet layers, and more specifically fewer than 5 single sheet layers.

In an embodiment, the first or second nanoparticle can be derivatized to include functional groups such as, for example, epoxy, ether, ketone, alkaryl, lactone, alkyl, alkoxy, haloakyl, cycloalkyl, heterocycloalkyl, cycloalkyloxy, aryl, aralkyl, aryloxy, aralkyloxy, heteroaryl, heteroaralkyl, alkenyl, alkynyl, amine, alkyleneamine, aryleneamine, alkenyleneamine, hydroxy, carboxy (e.g., a carboxylic acid group or salt), halogen, hydrogen, or a combination comprising at least one of the forgoing functional groups. The functional group can also include a polymeric or oligomeric group bonded to the first or second nanoparticle. Exemplary polymeric or oligomeric groups are polyethers, polyols, polyalkanes, polysulfone, cellulose, polyalkyne, polyvinyl, acrylic, polyamide, polyamine, polyheteroaromatic, polydiene, polyolefin, polyester, polyketone, or a hydrocarbon or siloxane chain (branched or straight chain) that contains a functional group such as, for example, epoxy, ether, ketone, alkaryl, lactone, alkyl, alkoxy, haloakyl, cycloalkyl, heterocycloalkyl, cycloalkyloxy, aryl, aralkyl, aryloxy, aralkyloxy, heteroaryl, heteroaralkyl, alkenyl, alkynyl, amine, alkyleneamine, aryleneamine, alkenyleneamine, hydroxy, carboxy (e.g., a carboxylic acid group or salt), halogen, hydrogen, or a combination comprising at least one of the forgoing functional groups. The first and second nanoparticles can be derivatized to introduce chemical functionality to the nanoparticle. For example, for nanographene, the surface and/or edges of the nanographene sheet is derivatized to increase dispersibility in and interaction with the polymer matrix. In an embodiment, the derivatized first or second nanoparticle can be hydrophilic, hydrophobic, oxophilic, lipophilic, oleophobic, oleophilic, or may possess a combination of these properties to provide a balance of desirable net properties, by use of different functional groups.

In an embodiment, the first or second nanoparticle is derivatized by, for example, amination to include amine groups, where amination may be accomplished by nitration followed by reduction, or by nucleophilic substitution of a leaving group by an amine, substituted amine, or protected amine, followed by deprotection as necessary. In another embodiment, a first or second nanoparticle, e.g., nanographene, can be derivatized by oxidative methods to produce an epoxy, hydroxy group or glycol group using a peroxide, or as applicable by cleavage of a double bond by for example a metal mediated oxidation such as a permanganate oxidation to form ketone, aldehyde, or carboxylic acid functional groups.

Where the functional groups are alkyl, aryl, aralkyl, alkaryl, or a combination of these groups, the functional groups can be attached directly to the derivatized first or second nanoparticle by a carbon-carbon bond (or carbon-silicon bond for silsesquioxanes) without intervening heteroatoms, to provide greater thermal and/or chemical stability, to the derivatized first or second nanoparticle, as well as a more efficient synthetic process requiring fewer steps; by a carbon-oxygen (or silicon-oxygen for silsesquioxanes) bond (where the first or second nanoparticle contains an oxygen-containing functional group such as hydroxy or carboxylic acid); or by a carbon-nitrogen (or silicon-nitrogen for silsesquioxanes) bond (where the first or second nanoparticle contains a nitrogen-containing functional group such as amine or amide). In an embodiment, the first or second nanoparticle can be derivatized by metal mediated reaction with a C₆₋₃₀ aryl or C₇₋₃₀ aralkyl halide (F, Cl, Br, I) in a carbon-carbon (or silicon-carbon) bond forming step, such as by a palladium-mediated reaction such as the Stille reaction, Suzuki coupling, or diazo coupling, or by an organocopper coupling reaction. In another embodiment, a first or second nanoparticle, such as a graphene, can be directly metallated by reaction with, e.g., an alkali metal such as lithium, sodium, or potassium, followed by reaction with a C₁₋₃₀ alkyl or C₇₋₃₀ alkaryl compound with a leaving group such as a halide (Cl, Br, I) or other leaving group (e.g., tosylate, mesylate, etc.) in a carbon-carbon bond forming step. The aryl or aralkyl halide, or the alkyl or alkaryl compound, can be substituted with a functional group such as hydroxy, carboxy, ether, or the like. Exemplary groups include, for example, hydroxy groups, carboxylic acid groups, alkyl groups such as methyl, ethyl, propyl, butyl, pentyl, hexyl, octyl, dodecyl, octadecyl, and the like; aryl groups including phenyl and hydroxyphenyl; aralkyl groups such as benzyl groups attached via the aryl portion, such as in a 4-methylphenyl, 4-hydroxymethylphenyl, or 4-(2-hydroxyethyl)phenyl (also referred to as a phenethylalcohol) group, or the like, or aralkyl groups attached at the benzylic (alkyl) position such as found in a phenylmethyl or 4-hydroxyphenyl methyl group, at the 2-position in a phenethyl or 4-hydroxyphenethyl group, or the like. In an exemplary embodiment, the derivatized second nanoparticle is graphene substituted with a benzyl, 4-hydroxybenzyl, phenethyl, 4-hydroxyphenethyl, 4-hydroxymethylphenyl, 4-(2-hydroxyethyl)phenyl group, or a combination comprising at least one of the foregoing groups. In some embodiments, the second nanoparticle is an oxide of graphene or nanographite.

According to an embodiment, the first nanoparticle is a silsesquioxane comprising a functional group bonded to a silicone atom of the silsesquioxane. In a specific embodiment, the functional group bonded to the silicon atom comprises an alkyl, alkoxy, haloakyl, cycloalkyl, heterocycloalkyl, cycloalkyloxy, aryl, aralkyl, aryloxy, aralkyloxy, heteroaryl, heteroaralkyl, alkenyl, alkynyl, amine, alkyleneamine, aryleneamine, alkenyleneamine, hydroxy, carboxyl, ether, epoxy, ketone, halogen, hydrogen, or combination comprising at least one of the foregoing. Thus, the silsesquioxane derivatized with a functional group includes a group such as an alcohol, amine, carboxylic acid, epoxy, ether, fluoroalkyl, halide, imide, ketone, methacrylate, acrylate, silica, nitrile, norbornenyl, olefin, polyethylene glycol (PEG), silane, silanol, sulfonate, thiol, and the like. Furthermore, the first nanoparticle can have from one functional group to as many functional groups as there are silicon atoms in the cage structure of the first nanoparticle. In a specific embodiment, a derivatized octasilsesquioxane R₈₋ₙHₙ(SiO_{1.5})₈ (where 0≦n≦8, and R can be a same or different functional group), the number of functional groups varies with the number of silicon atoms in the cage structure, i.e., from 0 to 8 functional groups.

Exemplary silsesquioxanes having a closed cage structure include 1-allyl-3,5,7,9,11,13,15-heptacyclopentylpentacyclo[9.5.1.1 (3,9).1(5,15).1(7,13)]octasiloxane; 1-allyl-3,5,7,9,11,13,15-heptaisobutylpentacyclo [9.5.1.1 (3,9).1 (5,15).1(7,13)]octasiloxane; 1-[3-(2-aminoethyl)amino]propyl-3,5,7,9,11,13,15-isobutylpentacyclo [9.5.1.1(3,9).1(5,15).1(7,13)]octasiloxane; 1-chlorobenzylethyl-3,5,7,9,11,13,15-heptaisobutylpentacyclo [9.5.1.1(3,9).1(5,15).1(7,13)]octasiloxane; 1-(4-chlorobenzyl)-3,5,7,9,11,13,15-heptacyclopentylpentacyclo [9.5.1.1(3,9).1(5,15).1(7,13)]octasiloxane; 1-chloropropyl-3,5,7,9,11,13,15-isobutylpentacyclo [9.5.1.1(3,9).1(5,15).1(7,13)]octasiloxane; (cyanopropyldimethylsilyloxy)heptacyclopentylpentacyclooctasiloxane; 1-(2-trans-cyclohexanediol)ethyl-3,5,7,9,11,13,15-isobutylpentacyclo [9.5.1.1(3,9).1(5,15).1 (7,13)]octasiloxane; 1-(3-cyclohexen-1-yl)-3,5,7,9,11,13,15-heptacyclopentylpentacyclo [9.5.1.1 (3,9).1(5,15).1(7,13)]octasiloxane; dodecaphenyl-dodecasiloxane; 1-[2-(3,4-epoxycyclohexyl)ethyl]-3,5,7,9,11,13,15-isobutylpentacyclo [9.5.1.1(3,9).1(5,15).1(7,13)]octasiloxane; 1,3,5,7,9,11,13-heptacyclopentyl-15-glycidylpentacyclo [9.5.1.1(3,9).1(5,15).1(7,13)]octasiloxane; 1-(3-glycidyl)propoxy-3,5,7,9,11,13,15-isobutylpentacyclo [9.5.1.1(3,9).1(5,15).1(7,13)] octasiloxane; octakis(tetramethylammonium) pentacyclo [9.5.1.1(3,9).1(5,15).1(7,13)]octasiloxane-1,3,5,7,9,11,13,15-octakis(yloxide) hydrate; 3-hydroxypropylheptaisobutyl-octasiloxane; 1-(3-mercapto)propyl-3,5,7,9,11,13,15 -isobutylpentacyclo [9.5.1.1(3,9).1(5,15).1(7,13)]octasiloxane; octacyclohexenylethyldimethylsilyloxy-octasiloxane; 1,3,5,7,9,11,13,15-octacyclohexylpentacyclooctasiloxane; octa[(1,2-epoxy-4-ethylcyclohexyl)dimethylsiloxy]octasiloxane; octa[(3-glycidyloxypropyl)dimethylsiloxy]octasiloxane; octa[(3-hydroxypropyl)dimethylsiloxy]octasiloxane; 1,3,5,7,9,11,13,15-octakis [2-(chlorodimethylsilyl)ethyl]pentacyclo [9.5.1.1(3,9).1(5,15).1(7,13)]octasiloxane; 1,3,5,7,9,11,13,15-octakis(dimethylsilyloxy)pentacyclo [9.5.1.1(3,9).1(5,15).1(7,13)]octasiloxane; 1,3,5,7,9,11,13,15-octamethylpentacyclo [9.5.1.1(3,9).1(5,15).1(7,13)]octasiloxane; 1,3,5,7,9,11,13,15-octaphenylpentacyclo [9.5.1.1(3,9).1(5,15).1(7,13)]octasiloxane; 1,3,5,7,9,11,13,15-octa(2-trichlorosilyl)ethyl)pentacyclo [9.5.1.1(3,9).1(5,15).1(7,13)]octasiloxane; 1,3,5,7,9,11,13,15-octavinylpentacyclo [9.5.1.1(3,9).1(5,15).1(7,13)] octasiloxane; 1-(2,3-propanediol)propoxy-3,5,7,9,11,13,15-isobutylpentacyclo-[9.5.1.1(3,9).1(5,15).1(7,13)]octasiloxane; 3-(3,5,7,9,11,13,15-heptaisobutylpentacyclo [9.5.1.1(3,9).1(5,15).1(7,13)]octasiloxan-1-yl)propylmethacrylate; (3-tosyloxypropyl)-heptaisobutyloctas iloxane; 1-(trivinyls ilyloxy)-3,5,7,9,11,13,15-heptacyclopentylpentacyclo [9.5.1.1(3,9).1(5,15).1(7,13)]octasiloxane; 1-vinyl-3,5,7,9,11,13,15-isobutylpentacyclo [9.5.1.1(3,9).1(5,15).1(7,13)]octasiloxane, (3-(2,2-bis(hydroxymethyl)butoxy)propyl)dimethyls iloxy-3,5,7,9,11,13,15-isobutylpentacyclo [9.5.1.1.(3,9).1(5,15).1(7,13)]octasiloxane; octa(3-hydroxy-3-methylbutyldimethylsiloxy)octasiloxane; 1-(3-amino)propyl-3,5,7,9,11,13,15-isobutylpentacyclo [9.5.1.1.(3,9).1(5,15).1(7,13)]octasiloxane; 1-(3-amino)propyl-3,5,7,9,11,13,15-isooctylpentacyclo [9.5.1.1.(3,9).1(5,15).1(7,13)]octasiloxane; 1,3,5,7,9,11,13,15-octaaminophenylpentacyclo [9.5.1 (3,9).1(5,15).1(7,13)]octasiloxane; octan-phenylaminopropyl)-octasiloxane; n-methylaminopropyl-heptaisobutyl-octasiloxane; octaethylammoniumoctasiloxane chloride; 1-(4-amino)phenyl-3,5,7,9,11,13,15-cyclohexlpentacyclo [9.5.1.1(3,9).1(5,15).1(7,13)]octasiloxane; 1-(amino)phenyl-3,5,7,9,11,13,15-cyclohexlpentacyclo [9.5.1.1(3,9).1 (5,15).1(7,13)]octasiloxane; 1-(4-amino)phenyl-3,5,7,9,11,13,15-heptaisobutylpentacyclo [9.5.1.1 (3,9).1 (5,15).1(7,13)]octasiloxane; 1-(amino)phenyl-3,5,7,9,11,13,15-heptaisobutylpentacylco [9.5.1.1(3,9).1(5,15).1 (7,13)]octasiloxane; 1-[(3-maleamic acid)propyl]-3,5,7,9,11,13,15-heptacyclohexylpentacyclo [9.5 .1.1(3,9).1(5,15).1(7,13)]-octasiloxane; 1-[(3-maleamic acid)propyl]-3,5,7,9,11,13,15 -heptaisobutylpentacyclo [9.5.1.1(3,9).1(5,15).1(7,13)]-octasiloxane; octamaleamic acid octasiloxane; trimethoxy-[2-(7-oxabicyclo[4.1.0]hept-3-yl)ethyl]silane, hydrolyzed; 2-[[3 -(trimethoxysilyl)propoxy]methyl]-oxirane, hydrolyzed; ethyl 3,5,7,9,11,13,15-heptaethylpentacyclo [9.5.1.1(3,9).1(5,15).1(7,13)]octasiloxane-1-undecanoate; 1-(3-glycidyl)propoxy-3,5,7,9,11,13,15-isooctylpentacyclo[9.5.1.1(3,9).1(5,15).1(7,13)]octasiloxane; 3,7,14-tris {[3-(epoxypropoxy)propyl]dimethylsilyloxy}-1,3,5,7,9,11,14-heptacyclohexyltricyclo [7.3.3.1(5,11)]heptasiloxane; 3,7,14-tris {[3-(epoxypropoxy)propyl]dimethylsilyloxy}-1,3,5,7,9,11,14-heptaisobutyltricyclo [7.3.3.1(5,11)]heptasiloxane; octatrifluoropropyloctasiloxane; endo-3,7,14-trifluoropropyl-1,3,5,7,9,11,14-heptaisobutyltricyclo [7.3.3.1(5,11)]heptasiloxane; 1-chlorobenzyl-3,5,7,9,11,13,15-heptaisobutylpentacyclo [9.5.1.1 (3,9).1 (5,15).1(7,13)]octasiloxane; 1,3,5,7,9,11,13,15-octakis(1,2-dibromoethyl)-pentacyclo [9.5.1.1(3,9).1(5,15).1 (7,13)]octasiloxane; 1-[(3-maleimide)propyl]-3,5,7,9,11,13,15-heptacyclohexylpentacyclo [9.5.1.1(3,9).1(5,15).1 (7,13)]-octasiloxane; 1-[(3-maleimide)propyl]-3,5,7,9,11,13,15-heptaisobutylpentacyclo [9.5.1.1(3,9).1 (5,15).1(7,13)]-octasiloxane; 1,3,5,7,9,11,13,15-heptaisobutylpentacyclo [9.5.1.1 (3,9).1 (5,15).1(7,13)]octasiloxan-1-yl)propylacrylate; 3-[3,5,7,9,11,13,15 -heptacyclohexylpentacyclo [9.5.1.1 (3,9).1(5,15).1(7,13)]octasiloxan-1-yl]methylmethacrylate; 3-[3,5,7,9,11,13,15-heptaisobutylpentacyclo [9.5.1.1 (3,9).1 (5,15).1(7,13)]octasiloxan-1-yl]methylmethacrylate; 3-[3,5,7,9,11,13,15 -heptaethylpentacyclo[9.5. 1.1 (3,9).1 (5,15).1(7,13)]octasiloxan-1-yl]methylmethacrylate; 3-[3,5,7,9,11,13,15-heptaethylpentacyclo [9.5.1.1(3,9).1(5,15).1 (7,13)]octasiloxan-1-yl]propylmethacrylate; 3-[3,5,7,9,11,13,15-heptaisooctylpentacyclo [9.5.1.1(3,9).1(5,15).1 (7,13)]octasiloxanlyl]methylmethacrylate; 3-(3,5,7,9,11,13,15-heptaisooctylpentacyclo [9.5.1.1 (3,9).1(5,15).1(7,13)]octasiloxan-1-yl)propylmethacrylate; 3-(3,5,7,9,11,13,15-heptaphenylpentacyclo [9.5.1.1 (3,9).1(5,15). 1(7,13)]octasiloxan-1-yl)propylmethacrylate; octasiloxa-octapropylmethacrylate; octasiloxa-octapropylacrylate; dodecaphenyldecasiloxane; octaisooctyloctasiloxane; phenylheptaisobutyloctasiloxane; phenylheptaisooctyloctasiloxane; isooctylhetpaphenyloctasiloxane; octaisobutyloctasiloxane; octamethyloctasiloxane; octaphenyloctasiloxane; octakis(tetramethylammonium)pentacyclo [9.5.1.1 (3,9).1(5,15).1(7,13)]octasiloxane 1,3,5,7,9,11,13,15 -octakis(cyloxide)hydrate; octakis(trimethylsiloxy)pentacyclo[9.5.1.1 (3,9).1 (5,15).1(7,13)]octasiloxane; 3,5,7,9,11,13,15-heptaisobutylpentacyclo [9.5.1.1(3,9).1(5,15).1 (7,13)]octasiloxane-1-butyronitrile; 1-[2-(5-norbornen-2-yl)ethyl]-3,5,7,9,11,13,15 -heptaethylpentacyclo [9.5.1.1(3,9).1(7,13)]octasiloxane; 1-[2-(5-norbornen-2-yl)ethyl]-3,5,7,9,11,13,15-heptaisobutylpentacyclo [9.5.1.1(3,9).1(7,13)]octasiloxane; 1-allyl-3,5,7,9,11,13,15-heptaisobutylpentacyclo [9.5.1.1(3,9).1(7,13)]octasiloxane; 1,3,5,7,9,11,13-heptaisobutyl-15-vinylpentacyclo [9.5.1.1(3,9).1(5,15).1(7,13)] octasiloxane; 1,3,5,7,9,11,13,15-octa[2-(3-cyclohexenyl)ethyldimethylsiloxy]pentacyclo [9.5.1.1 (3,9).1(5,15).1(7,13)]octasiloxane; 1,3,5,7,9,11,13,15-octavinylpentacyclo [9.5.1.1(3,9).1 (5,15).1(7,13)]octasiloxane; 1,3,5,7,9,11,13,15-octa[vinyldimethylsiloxy]pentacyclo [9.5.1.1 (3,9).1(5,15).1(7,13)] octasiloxane; 1,3,5,7,9,11,13,15-octakis(dimethylsilyloxy)pentacyclo [9.5.1.1(3,9).1(5,15).1(7,13)]octasiloxane; 1,3,5,7,9,11,13,15-octahydropentacyclo [9.5.1.1(3,9).1(5,15).1 (7,13)]octasiloxane; 1-(3-mercapto)propyl-3,5,7,9,11,13,15-isobutylpentacyclo [9.5.1.1(3,9).1(5,15).1 (7,13)]octasiloxane; 1-(3-mercapto)propyl-3,5,7,9,11,13,15-isooctylpentacyclo [9.5.1.1(3,9).1(5,15).1(7,13)]octasiloxane; and the like.

Exemplary silsesquioxanes having an open cage structure include 1,3,5,7,9,11,14-heptacyclohexyltricyclo [7.3.3.1 (5, 11)]heptasiloxane-endo-3 ,7,14-triol; 1,3,5,7,9,11,14-heptacyclopentyltricyclo [7.3.3.1 (5,11)]heptasiloxane-endo-3,7,14-triol; 1,3,5,7,9,11-octaisobutyltetracyclo [7.3.3.1(5, 11)] octasiloxane-endo-3,7-diol; 1,3,5,7,9,11,14-heptaethyltricyclo [7.3.3.1 (5,11)]heptasiloxane-endo-3,7,14-triol; 1,3,5,7,9,11,14-heptaisobutyltricyclo [7.3.3.1 (5,11)]heptasiloxane-endo-3,7,14-triol; 1,3,5,7,9,11,14-heptaisobutyltricyclo [7.3.3.1 (5,110]heptasiloxane-endo-3,7,14-triol; 1,3,5,7,9,11,14-heptaphenyltricyclo [7.3.3.1 (5,11)]heptasiloxane-endo-3,7,14-triol; tricyclo [7.3.3.3 (3,7)]octasiloxane-5,11,14,17-tetraol-1,3,5,7,9,11,14,17-octaphenyl; 9-{dimethyl[2-(5-norbornen-2-yl)ethyl]silyloxy}-1,3,5,7,9,11,14-heptaisobutyltricyclo [7.3.3.1 5,11 ]heptasiloxane-1,5-diol; endo-3,7,14-tris {dimethyl [2-(5-norbornen-2-yl)ethyl]silyloxy}-1,3,5,7,9,11,14-heptaisobutyltricyclo [7.3.3.1(5,11)]heptasiloxane; [[dimethyl(trifluoromethyl)ethyl]silyloxy]heptacyclopentyltricyclo heptasiloxanediol; 1,3,5,7,9,11,14-heptacyclohexyltricyclo [7.3.3.1 (5, 11)]heptasiloxane-3,7,14-triol; 1,3,5,7,9,11,14-heptaisobutyltricyclo [7.3.3.1(5,11)]heptasiloxane-endo-3,7,14-triol; 1,3,5,7,9,11 -octacyclopentyltetracyclo [7.3.3.1 (5,11)] octasiloxane-endo-3,7-diol; 1,3,5,7,9,11,14-hepta-isooctyltricyclo [7.3.3.1 (5,11)]heptasiloxane-endo-3,7,14-triol; endo-3,7,14-trifluoro-1,3,5,7,9,11,14-heptacyclopentyltricyclo [7.3.3.1 (5,11)]heptasiloxane; endo-3,7,14-tris {dimethyl [2-(5-norbornen-2-yl)ethyl]silyloxy}-1,3,5,7,9,11,14-heptacyclopentyltricyclo [7.3.3.1(5,11)]heptasiloxane; tris((dimethyl(trifluoromethyl)ethyl)silyloxy)heptacyclopentyltricycloheptasiloxane; 3,7,14-tris {[3 -(epoxypropoxy)propyl]dimethylsilyloxy}-1,3,5,7,9,11,14-heptacyclopentyltricyclo [7.3.3.1(5,11)]heptasiloxane, and the like.

A combination of the silsesquioxanes with open cage structures and closed cage structures can be used as the first nanoparticle in conjunction with a combination of any of the second nanoparticles.

According to an embodiment, the first nanoparticle is bonded to the second nanoparticle. In one embodiment, the first nanoparticle can react with the second nanoparticle to form the bond therebetween. In a particular embodiment, the first and second nanoparticles are bonded via a functional group. Furthermore, any number of first nanoparticles can be bonded to any number of second nanoparticles, in any order or structural geometry.

In another embodiment, the nanofiller comprising the first and second nanoparticles is bonded to another component in the nanocomposite, including the polymer or reactive functional groups that may be present in the polymer. Such bonding between the nanofiller and polymer improves tethering of the nanofiller with the polymer. In an embodiment, the silsesquioxane of the nanofiller is bonded to the polymer. In another embodiment, the second nanoparticle is bonded to the nanofiller. In yet another embodiment, the first and second nanoparticles are both bonded to the polymer. The second nanoparticle can have a degree of derivatization that varies from 1 functional group for every 5 carbon centers to 1 functional group for every 100 carbon centers depending on the functional group.

The polymer of the nanocomposite can include a thermoset, thermoplastic, or a combination thereof. Moreover, the nanocomposite can include a blend of polymers, copolymers, terpolymers, or combinations comprising at least one of the foregoing polymers. The polymer can also be an oligomer, homopolymer, copolymer, block copolymer, alternating block copolymer, random polymer, random copolymer, random block copolymer, graft copolymer, star block copolymer, dendrimer, or the like, or a combination comprising at last one of the foregoing polymers.

A “thermoset polymer” solidifies when first heated under pressure, and thereafter may not melt or mold without destroying the original characteristics. Thermosetting polymeric materials can include epoxides, phenolics, melamines, ureas, polyurethanes, polysiloxanes, polymers including a suitable crosslinkable functional moiety, or a combination comprising at least one of the foregoing.

A thermoplastic polymer has a macromolecular structure that repeatedly softens when heated and hardens when cooled. Illustrative examples of thermoplastic polymeric materials include olefin-derived polymers, for example, polyethylene, polypropylene, and their copolymers; polymethylpentane-derived polymers, for example, polybutadiene, polyisoprene, and their copolymers; polymers of unsaturated carboxylic acids and their functional derivatives, for example, acrylic polymers such as poly (alkyl acrylates), poly (alkyl methacrylate), polyacrylamides, polyacrylonitrile, and polyacrylic acid; alkenylaromatic polymers, for example polystyrene, poly-alpha-methylstyrene, polyvinyltoluene, and rubber-modified polystyrenes; polyamides, for example, nylon-6, nylon-66, nylon-11, and nylon-12; polyesters, such as, poly(alkylene dicarboxylates), e.g., poly(ethylene terephthalate) (hereinafter sometimes designated “PET”), poly(1,4- butylene terephthalate) (hereinafter sometimes designated “PBT”), poly(trimethylene terephthalate) (hereinafter sometimes designated “PTT”), poly(ethylene naphthalate) (hereinafter sometimes designated “PEN”), poly(butylene naphthalate) (hereinafter sometimes designated “PBN”), poly(cyclohexanedimethanol terephthalate), poly(cyclohexanedimethanol-co-ethylene terephthalate) (hereinafter sometimes designated “PETG”), and poly(1,4-cyclohexanedimethyl-1,4-cyclohexanedicarboxylate) (hereinafter sometimes designated “PCCD”), and poly(alkylene arenedioates); polycarbonates; co-polycarbonates; co-polyestercarbonates; polysulfones; polyimides; polyarylene sulfides; polysulfide sulfones; and polyethers such as polyarylene ethers, polyphenylene ethers, polyethersulfones, polyetherimides, polyetherketones, polyetheretherketones; or blends or copolymers thereof.

In an embodiment, the nanocomposite also includes an auxiliary filler. A auxiliary filler, as used herein, includes a reinforcing or non-reinforcing auxiliary filler. Reinforcing auxiliary fillers include, for example, silica, glass fiber, carbon fiber, or carbon black, which can be added to the nanocomposite to increase strength. Non-reinforcing auxiliary fillers such as polytetrafluoroethylene (PTFE), molybdenum disulfide (MoS₂), or graphite can be added to the nanocomposite to increase lubrication. Other auxiliary fillers, such as a carbon nanotubes, nanoclays, or the like, can be incorporated into the nanocomposite to increase the strength and elongation of the material. The auxiliary fillers can further be functionalized to include grafts or functional groups to adjust properties such as solubility, surface charge, hydrophilicity, lipophilicity, and other properties. Combinations comprising at least one of the foregoing auxiliary fillers can be used. The auxiliary filler can be present in the nanocomposite in an amount from 0.5 wt % to 70 wt %, specifically 0.5 wt % to 50 wt %, and more specifically 0.5 wt % to 25 wt %, based on the weight of the nanocomposite.

The nanofiller can be present in the nanocomposite in an amount from 0.1 wt % to 90 wt %, specifically 0.1 wt % to 75 wt %, and more specifically 0.1 wt % to 30 wt % based on a weight of the nanocomposite. A ratio of the weight of the first nanoparticle to that of the second nanoparticle in the nanofiller can be from 1:500 to 500:1, specifically 1:300 to 300:1, more specifically 1:100 to 100:1, and even more specifically 1:50 to 50:1. The first nanoparticle, e.g., silsesquioxane, can be present in the nanocomposite in an amount from 0.1 wt % to 80 wt %, specifically 0.1 wt % to 60 wt %, and more specifically 0.1 wt % to 20 wt %, based on a weight of the nanocomposite. The second nanoparticle can be present in the nanocomposite in an amount from 0.1 wt % to 80 wt %, specifically 0.1 wt % to 60 wt %, and more specifically 0.1 wt % to 20 wt %, based on a weight of the nanocomposite.

In an embodiment, a process for making the nanocomposite includes combining a first nanoparticle, e.g., silsesquioxane, and a second nanoparticle, e.g., graphene, graphene fiber nanographite, or derivatives thereof. The silsesquioxane or second nanoparticle can be dispersed in a solvent, or a solvent can be added to the combination of the silsesquioxane and second nanoparticle. The solvent can be an inorganic solvent such as water, including deionized water, or buffered or pH adjusted water, mineral acid, or a combination comprising at least one of the foregoing, or an organic solvent comprising an alkane, alcohol, ketone, oils, ethers, amides, sulfones, sulfoxides, or a combination comprising at least one of the foregoing. Exemplary inorganic solvents include water, sulfuric acid, hydrochloric acid, or the like; exemplary oils include mineral oil, silicone oil, or the like; and exemplary organic solvents include alkanes such as hexane, heptane, 2,2,4-trimethylpentane, n-octane, cyclohexane, and the like; alcohols such as methanol, ethanol, propanol, isopropanol, butanol, t-butanol, octanol, cyclohexanol, ethylene glycol, ethylene glycol methyl ether, ethylene glycol ethyl ether, ethylene glycol butyl ether, propylene glycol, propylene glycol methyl ether, propylene glycol ethyl ether, and the like; ketones such as acetone, methyl-ethyl ketone, cyclohexanone methyletherketone, 2-heptanone, and the like; esters such as ethyl acetate, propylene glycol methyl ether acetate, ethyl lactate, and the like; ethers such as tetrahydrofuran, dioxane, and the like; polar aprotic solvents such as N,N-dimethylformamide, N-methylcaprolactam, N-methylpyrrolidine, dimethylsulfoxide, gamma-butyrolactone, or the like; or a combination comprising at least one of the foregoing.

After combining the silsesquioxane and second nanoparticle, the second nanoparticle is bonded to the silsesquioxane to make a nanofiller. Reaction conditions include a temperature or pressure effective to bond the silsesquioxane to the second nanoparticle. In an embodiment, the temperature is 35° C. to 250° C., and specifically 25° C. to 125° C. The pressure can be less than 1 atmosphere (atm) to 10 atm, specifically 1 atm to 7 atm, and more specifically 1 atm to 3 atm. A catalyst can be added to increase the reaction rate of bonding the silsesquioxane to the second nanoparticle. In an embodiment, a silicon atom of the cage structure of the silsesquioxane is bonded directly to the second nanoparticle. In another embodiment, a functional group attached to the silsesquioxane or second nanoparticle is used to bond the silsesquioxane to the second nanoparticle. In one embodiment, the functional group is attached to the silsesquioxane prior to reaction. In another embodiment, the functional group is attached to the second nanoparticle prior to reaction. Thus, in some embodiments, a functional group intercedes between the silsesquioxane and second nanoparticle to bond the silsesquioxane to the second nanoparticle. In a further embodiment, no functional group intercedes between the silsesquioxane and second nanoparticle such that the silsesquioxane and second nanoparticle are bonded directly to one another.

According to an embodiment, the nanofiller and polymer are dispersed to make the nanocomposite. The nanofiller (either the silsesquioxane or second nanoparticle) is derivatized with a functional group to facilitate dispersal with the polymer. In addition, the polymer can be derivatized with a functional group to improve the processing with the nanofiller. To improve mixing, the polymer and nanofiller can be dispersed in a solvent including inorganic solvents like water, or mineral acids such as sulfuric acid, or organic solvents including oils, alcohols and glycols, ketones such as methylethylketone (MEK), ethers such as tetrahydrofuran (THF), polar aprotic solvents such as N,N-dimethylformamide (DMF), dimethylsulfoxide (DMSO), or another solvent.

In a specific embodiment, a method for making a nanocomposite comprises combining, e.g., by blending, a polymer, and 0.1 to 40 wt % of a derivatized nanofiller based on the weight of the nanocomposite, the derivatized nanofiller including functional groups comprising alkyl, alkoxy, haloakyl, cycloalkyl, heterocycloalkyl, cycloalkyloxy, aryl, aralkyl, aryloxy, aralkyloxy, ether, epoxy, ketone, heteroaryl, heteroaralkyl, alkenyl, alkynyl, amine, alkyleneamine, aryleneamine, alkenyleneamine, hydroxy, carboxyl, halogen, or a combination comprising at least one of the forgoing functional groups.

In another embodiment, the nanofiller can be formulated as a solution or dispersion and cast or coated, or may be mechanically dispersed in the polymer. Dispersion of the nanofiller and the polymer can be accomplished by methods such as, for example, extrusion, blending, high shear mixing, rotary mixing, three-roll milling, solution mixing, and the like. The properties of the nanocomposite can be adjusted by the selection of polymer or nanofiller, e.g., derivatized graphene bonded to a silsesquioxane can be arranged or assembled in the polymer by taking advantage of the intrinsic surface properties of the graphene after exfoliation, in addition to a functional group that can be introduced by derivatization.

Rotational mixing is a mixing method in which the vessel containing the mixing components is rotated about its axis, while simultaneously processing at a fixed radius about a second rotational center. Thus, the vessel precesses to mix the nanofiller and polymer. Mixing in this way provides high shear and elimination of bubbles, while avoiding use of agitators which can lead to a non-homogeneous composition that may be caused by, for example, different mixing zones within a mixing vessel or bubbles generated by mixing and cavitation. Use of vacuum in processing can further improve both mechanical properties and (reduced) variability by removing volatile components and any adventitious bubbles that may form during the mixing process. An example of a rotational mixer which can provide suitable mixing of the components (i.e., of the polymer and nanofiller), with or without vacuum, is a THINKY® Rotational Vacuum Mixer AR 310 (available from Thinky, Inc.).

In another embodiment, mixing by a reactive injection molding-type process can be accomplished using two or more continuous feed streams, where the nanofiller can be included as a component of one of the feed streams (e.g., where the polymer is a polyurethane prepared using different feed streams, the nanofiller can be included in a diisocyanate or polyol, diamine, etc. stream, or in a separate stream as a suspension in a solvent). Mixing in such systems is accomplished by the flow within the mixing zone at the point of introduction of the components.

In an embodiment, the nanofiller is combined with the polymer, and then the nanofiller is bonded to the polymer. In a non-limiting embodiment, the nanofiller and polymer are combined, and a crosslinking reaction is initiated. In another embodiment, the nanofiller is introduced after initiating the crosslinking reaction. In an embodiment, the nanofiller is mixed with a thermosetting polymer precursor(s), e.g., precursors to a polyurethane, prior to a two-fold increase in the viscosity of the mixture, where including the nanofiller prior to the increase in viscosity ensures uniform dispersion of the nanofiller. In an alternative embodiment, a gradient in the concentration of the nanofiller with respect to the polymer is present in an article containing the nanocomposite.

In another embodiment, a method for making a nanocomposite comprises contacting the nanofiller and polymer with a curing agent, which includes a hardener, accelerator, catalyst, curative, initiator or the like. The curing agent is used to crosslink the polymer to itself or bond the nanofiller to the polymer. Therefore, the curing agent can be selected based on the polymer or nanofiller as well as the desired properties of the nanocomposite.

Curing agents include mercaptans, Lewis acid, dicyandiamide, aromatic diamines (e.g., 3,3′-diaminodiphenylsulfone, 4,4′-diaminodiphenylsulfone, and the like), imidazoles (e.g., 2-methyl imidazole, 2-isopropyl imidazole, 2-phenyl imidazole, 2-phenyl-4-methyl imidazole, 2-heptadecyl imidazole, 2-ethyl-4-methyl imidazole, 2-undecyl imidazole, 1-cyano ethyl-2-methyl imidazole, 1,4-dicyano-6-[2-methylimidazolyl-(1)]-ethyl-s-triazine, and 2,4-dicyano-6[2-undecylimidazolyl-(1)]-ethyl-s-triazine, and the like), anhydrides, alcohols, phenols (e.g., resorcinol, hydroquinone, N,N-bis(2-hydroxyethyl)aniline, p,p′-bis(2-hydroxyethylamino)diphenylmethane), and ureas (phenyl dimethyl urea, 4-chlorophenyl dimethyl urea, 2,4-toluene bis(dimethyl urea), 4,4′-methylene bis(phenyl dimethyl urea), cycloaliphatic bisurea, and the like). Exemplary anhydrides curing agents include methylhexahydrophthalic anhydride, 1,2-cyclohexanedicarboxylic anhydride, bicyclo [2.2.1 ]hept-5-ene-2,3-dicarboxylic anhydride, methylbicyclo [2.2.1 ]hept-5-ene-2,3-dicarboxylic anhydride, phthalic anhydride, pyromellitic dianhydride, hexahydrophthalic anhydride, dodecenylsuccinic anhydride, dichloromaleic anhydride, chlorendic anhydride, tetrachlorophthalic anhydride, and the like. Exemplary alcohols include methanol, ethanol, and higher alcohol compounds such as phenolic resins, Novolac systems, bisphenols, glycol, glycerol, and the like.

Other curing agents include amino compounds (primary, secondary, or tertiary amines, e.g., triethylamine, tributylamine, N-methylmorpholine, N-ethylmorpholine, 1,4diaza-bicylo-(2,2,2)-octane, N-cetyl dimethylamine, N-methyl-N′-dimethylaminoethyl-piperazine, N,N-dimethylbenzylamine, N,N-dimethylcyclohexylamine, and 1,2-dimethylimidazole, and the like), amine salts, and quaternary ammonium compounds, amine-epoxy adducts, boron trihalide amine adducts, and guanidines. Suitable boron trihalide adducts include boron trichloride adducts of amines such as monoethanolamine, diethylamine, dioctylmethylamine, triethylamine, pyridine, benzylamine, benzyldimethyl amine, and the like. Additional curing agents include phosphine compounds, such as tributylphosphine, triphenylphosphine, tris(dimethoxyphenyl)phosphine, tris(hydroxypropyl)phosphine and tris(cyanoethyl)phosphine; phosphonium salts, such as tetraphenylphosphonium tetraphenylborate, methyltributylphosphonium tetraphenylborate and methyltricyanoethyl phosphonium tetraphenylborate; and the like. Curing agents are commercially available from CVC Specialty Chemicals such as those sold under the trademark Omicure U and Omicure B. Other curing agents are available through Air Products, including those sold under the trademark Imicure, Curezol, and Amicure UR, and also from Degussa sold under the trademark Dyhard UR and Dyhard MI.

The curing agent can be present in an amount from 0.01 wt % to 10 wt %, specifically 0.01 wt % to 5 wt %, and more specifically 0.01 wt % to 1 wt %, based on the weight of the nanofiller and polymer.

The pressure and temperature can be controlled during bonding of the nanofiller to the polymer. The temperature can be from 20° C. to 250° C., specifically 25° C. to 200° C., and mores specifically 25° C. to 180° C. The pressure can be from 1 atm to 10 atm, specifically 1 atm to 7 atm, and more specifically 1 atm to 3 atm.

According to an embodiment, the nanofiller and polymer are combined and mixed with a hardener. The composition is held at room temperature for 24 hours to allow formation of bonds between the nanofiller and the polymer or crosslinking among any of these components (e.g., crosslinks between portions of the polymer or polymer-nanofiller). Alternatively, the temperature is increased to 180° C. and maintained there for 3 hours. In another embodiment, the nanofiller and polymer can be disposed in an mold (e.g., a compression mold) to form the nanocomposite.

The nanocomposite and articles made from the nanocomposite have advantageous properties. The nanocomposite is a high temperature composite with favorable decomposition and flame retardant properties. In an embodiment, the nanocomposite has a thermal decomposition temperature equal to or greater than 150° C., specifically 200° C., and more specifically 350° C. The nanocomposite also has a char content equal to or greater than 35 wt %, specifically 25 wt %, and more specifically 10 wt %, based on a weight of the nanocomposite, at a temperature greater than the thermal decomposition temperature of the nanocomposite. The nanocomposite has a time to ignition equal to or greater than 30 seconds, specifically 45 seconds, and more specifically 55 seconds. The nanocomposite has a self-extinguish time equal to or less than 40 seconds, specifically 30 seconds, and more specifically 20 seconds.

The nanocomposite herein has beneficial material strength, including a tensile strength from 50 megapascals (MPa) to 8000 MPa, specifically 300 MPa to 7000 MPa, and more specifically 500 MPa to 7000 MPa. Moreover, the nanocomposite is resistant to solvent diffusion through the nanocomposite. In addition, the nanocomposite has a glass transition temperature equal to or greater than 100° C., specifically 150° C., and more specifically 200° C.

The nanocomposite having these properties is an outcome of using a nanofiller having a first nanoparticle (e.g., silsesquioxane) bonded to a second nanoparticle dispersed with a polymer. The methods and nanocomposite can be used as a coating or part, for example, a bag for an electro submersible pump (ESP), gear, housing, fiber optic cable, logging tool cable, and the like. In addition, items such as a filter, membrane, conduit, partition, and the like can be prepared from the nanocomposite. In a specific embodiment, an optical fiber is disposed in the nanocomposite (which is in a fluid or powder state), and the nanocomposite is allowed to harden or cure on the surface of the optical fiber, forming a nanocomposite coated fiber optic cable. In another embodiment, the nanofiller and polymer are introduced into a mold, which is heated to bond the nanofiller and polymer under compression. The nanocomposite thus formed can be removed subsequently from the mold to produce, for example, a gear.

Articles may be formed from the polymer nanocomposite prepared by the above method. As the nanocomposite herein has beneficial mechanical and thermal properties, articles prepared from the nanocomposite will have improved mechanical properties, reliability, and environmental stability. Thus, in an embodiment, an article comprises the polymer nanocomposite. The polymer nanocomposite may be used to form all or a portion of an article such as a gear. In some embodiments, an article of the nanocomposite can be useful in a downhole application, such as for example a packer element, a blow out preventer element, a torsional spring of a sub surface safety valve, a submersible pump motor protector bag, a blow out preventer element, a sensor protector, a sucker rod, an O-ring, a T-ring, a gasket, a sucker rod seal, a pump shaft seal, a tube seal, a valve seal, a seal for an electrical component, an insulator for an electrical component, a seal for a drilling motor, or the like.

While one or more embodiments have been shown and described, modifications and substitutions may be made thereto without departing from the spirit and scope of the invention. Accordingly, it is to be understood that the present invention has been described by way of illustrations and not limitation. Embodiments herein are can be used independently or can be combined.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” It should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). The conjunction “or” is used to link objects of a list or alternatives and is not disjunctive, rather the elements can be used separately or can be combined together under appropriate circumstances.

What is claimed is:

1. A nanocomposite comprising:
a polymer; and
a nanofiller disposed in the polymer, the nanofiller comprising a first nanoparticle bonded to a second nanoparticle, and the first nanoparticle being different than the second nanoparticle.

2. The nanocomposite of claim 1, wherein the first nanoparticle comprises a silsesquioxane which has a closed cage structure, an open cage structure, or a combination comprising at least one of the foregoing.

3. The nanocomposite of claim 2, wherein the silsesquioxane comprises a functional group bonded to a silicone atom of the silsesquioxane.

4. The nanocomposite of the claim 3, wherein the functional group bonded to the silicon atom comprises an alkyl, alkoxy, haloakyl, cycloalkyl, heterocycloalkyl, cycloalkyloxy, aryl, aralkyl, aryloxy, aralkyloxy, ether, epoxy, ketone, heteroaryl, heteroaralkyl, alkenyl, alkynyl, amine, alkyleneamine, aryleneamine, alkenyleneamine, hydroxy, carboxyl, halogen, hydrogen, or combination comprising at least one of the foregoing.

5. The nanocomposite of claim 2, wherein a cage structure of the silsesquioxane comprises from 4 to 30 silicon atoms, each silicon atom being bonded to oxygen.

6. The nanocomposite of claim 2, wherein the second nanoparticle comprises graphene, graphene fiber, nanographite, carbon nanotubes, oxides thereof, or a combination comprising at least one of the foregoing.

7. The nanocomposite of claim 1, wherein the polymer comprises epoxides, phenolics, melamines, ureas, polyurethanes, polysiloxanes, polyethylenes, polypropylenes, polybutadienes, polyisoprenes, acrylic polymers, polyacrylamides, polyacrylonitriles, polyacrylic acids, alkenylaromatic polymers, polyamides, polyesters, polycarbonates, polysulfones, polyimides, polyarylene sulfides, polysulfide sulfones, polyethers, or a combination comprising at least one of the foregoing.

8. The nanocomposite of claim 1, wherein the nanofiller is bonded to the polymer.

9. The nanocomposite of claim 8, wherein the silsesquioxane of the nanofiller is bonded to the polymer.

10. The nanocomposite of claim 1, wherein the nanofiller is present in an amount from 0.1 wt % to 90 wt %, based on a weight of the nanocomposite.

11. The nanocomposite of claim 6, wherein a ratio of the weight of the first nanoparticle to that of the second nanoparticle in the nanofiller is from 1:500 to 500:1.

12. The nanocomposite of claim 1, wherein the nanocomposite has a thermal decomposition temperature equal to or greater than 150° C.

13. The nanocomposite of claim 12, wherein the nanocomposite has a char content of equal to or greater than 10 wt %, based on a weight of the nanocomposite, at a temperature greater than the thermal decomposition temperature of the nanocomposite.

14. The nanocomposite of claim 1, wherein the nanocomposite has a time to ignition equal to or greater than 30 seconds.

15. The nanocomposite of claim 1, wherein the nanocomposite has a self-extinguish time equal to or less than 20 seconds.

16. The nanocomposite of claim 1, wherein the nanocomposite has a glass transition temperature equal to or greater than 150° C.

17. A process for making a nanocomposite, the process comprising:
combining a silsesquioxane and a nanoparticle;
bonding the nanoparticle to the silsesquioxane to make a nanofiller; and
dispersing the nanofiller in a polymer to make the nanocomposite.

18. The process of claim 17, further comprising bonding the nanofiller to the polymer.

19. The process of claim 17, wherein the nanoparticle comprises graphene, graphite, a derivative thereof, or a combination comprising at least one of the foregoing.

20. The process of claim 17, further comprising disposing, in the nanocomposite, an auxiliary filler comprising silica, glass fiber, carbon fiber, carbon black, polytetrafluoroethylene, molybdenum disulfide, carbon nanotubes, nanoclay, or a combination comprising at least one of the foregoing.
